(19) United States
(12) Patent Application Publication
(10) Pub. No.: US 2018/0268020 A1
(43) Pub. Date: Sep. 20, 2018

(54) TRANSACTION PROCESSING SYSTEM AND TRANSACTION CONTROL METHOD

(71) Applicant: Nomura Research Institute, Ltd., Tokyo (JP)

(72) Inventors: Minoru MONDA, Tokyo (JP); Shimpei YAGYU, Tokyo (JP)

(73) Assignee: Nomura Research Institute, Ltd., Tokyo (JP)

(21) Appl. No.: 15/983,930

(22) Filed: May 18, 2018

Related U.S. Application Data
(63) Continuation of application No. PCT/JP2015/083700, filed on Dec. 1, 2015.

(51) Int. Cl. G06F 17/30

(52) U.S. Cl. CPC G06F 17/30371; G06F 17/30368

(57) ABSTRACT

There is provided a transaction control system enabling, even when a message having incomplete data is input, a service provider to independently correct the incomplete data to make a retry, without exerting influence on processing of the subsequent message and without increasing the operation burden of an operator. A business application acquires a first message from a first queue after starting transaction processing, checks whether identification information has been recorded in an exception-management table, and performs business processing when no record has been made. The business application outputs a third message including the contents of the first message to a third queue according to exception processing when the record has been made, and commits the transaction processing. The business application records the identification information regarding the first message into the exception-management table when an exception occurs during the performance of the business processing, and rolls back the transaction processing.

### TECHNICAL FIELD

The present invention relates to a transaction processing technique, and more particularly relates to an effective technique to be applied to a transaction processing system and a transaction control method that perform control of, for example, delivering and receiving data with message queuing (MQ).

### BACKGROUND ART

In some cases, an information processing system that performs transaction processing, causes at least one component or subsystem implemented in different processing units (hereinafter, also collectively referred to as “subsystem”) to cooperate with each other through a queue in a “bucket brigade” manner, in order to achieve a series of pieces of business processing, like a system that achieves straight through processing (STP) in securities trading. As a result, achievement of loose coupling between the subsystems enables availability and maintainability/expandability to improve.

As a technique relating to transaction processing with cooperation between subsystems with MQ, JP 2006-133894 A (Patent Literature 1) describes the following technique. When a message for flow control is transmitted to a queue, a message processing unit of a server acquires message data from a business database and calls and executes an application on the basis of a flow definition included in the message data. Then, a message including the flow definition and an executed result of the application is transmitted to the next destination to achieve cooperative processing of the application based on the flow definition, through no specific management server.

JP 2009-9613 A (Patent Literature 2) describes the following transaction system. A transaction is divided into sub-transactions in predetermined units, such as a brand, a terminal, a market, and a server, so as to be subjected to parallel processing. Respective processing results of the sub-transactions are stored in a database in the predetermined units. The processing results stored in the database are migrated between the sub-transactions, with transmission and reception of a message as a trigger, so that the parallel processing of the sub-transactions is achieved with the processing order ensured.

JP 2004-318560 A (Patent Literature 3) discloses the following description. When an abnormality occurs during performance of transaction processing with sequential extraction of messages connected to a message queue, a range of influence in the occurrence of the abnormality is reduced with destruction of messages for performance of a series of pieces of processing including, as a constituent element, a message being the cause of the abnormality in the messages connected to the message queue.

### CITATION LIST

### Patent Literature

Patent Literature 1: JP 2006-133894 A

Patent Literature 2: JP 2009-9613 A

Patent Literature 3: JP 2004-318560 A

### SUMMARY OF INVENTION

### Technical Problem

For transaction processing with cooperation between subsystems with MQ as the conventional techniques, there is a need to improve the availability of online business with implementation of a scheme of preventing application processing from stopping due to a message including incomplete data. For example, in a case where a message extracted from an input queue has incomplete data in a subsystem, a business exception (error) occurs in an application of the subsystem.

In this case, rolling back the transaction together with the message having the incomplete data as a measure against the occurrence of the exception, returns the message having the incomplete data to the input queue. That causes processing with re-extraction of the message to be performed. As a result, the same exception occurrence loops and additionally the subsequent message is delayed. Particularly, in a case where a system is shared by a plurality of service providers, such as software as a service (SaaS) and an application service provider (ASP), the influence of delay is exerted on processing of the other service providers.

In contrast to this, for example, application of the mechanism described in Patent Literature 3 can prevent the exception occurrence from looping, but recovery of the transaction according to the destroyed messages has not been considered. In this respect, for example, it can be considered that a measure such as output of data according to the destroyed messages to a file, is adopted. Even in this case, eventually, there is a need to correct the incomplete data in order to recover the transaction. In principle, only an intended service provider has the authority to perform the correction (namely, having the authority to correct data in production environment). In this case, the conventional techniques need a measure, for example, the system operator passes the incomplete data to the service provider or undertakes and executes the correction with reception of approval or an instruction from the service provider, and thus the operation burden of the operator increases.

An object of the present invention is to provide a transaction processing system and a transaction control method that enable, even in a case where a message having incomplete data is input, a service provider to independently correct the incomplete data to make a retry without exerting influence on processing of the subsequent message and without increasing the operation burden of the operator.

The foregoing and other objects and novel features of the present invention will be clarified by the description herein and the attached drawings.

### Solution to Problem

A representative embodiment of the invention disclosed in the present application will be briefly overviewed below.

A transaction control system according to the representative embodiment of the present invention, including at least one business application configured to perform transaction processing including: acquiring a first message from a first queue; performing business processing including accessing to a database, for at least one service provider, based on the first message; and outputting a second message to a second queue, includes the following feature.

That is, the transaction control system includes an exception-management table into which identification information regarding the first message is to be recorded, the first message having occurrence of an exception during the performance of the business processing. The at least one business application acquires the first message from the first queue after starting the transaction processing, checks whether the identification information according to the first message acquired has been recorded in the exception-management table, performs the business processing in a case where no record has been made, outputs a third message including contents of the first message to a third queue according to exception processing in a case where the record has been made, and commits the transaction processing. The at least one business application records the identification information regarding the first message into the exception-management table in a case where the exception occurs during the performance of the business processing, and rolls back the transaction processing.

### Advantageous Effects of Invention

The advantageous effect of the representative embodiment of the invention disclosed in the present application will be briefly described below.

That is, according to the representative embodiment of the present invention, even when a message having incomplete data is input, a service provider can independently correct the incomplete data and make a retry, without exerting influence on processing of the subsequent message and without increasing the operation burden of an operator.

### BRIEF DESCRIPTION OF DRAWINGS

FIG. 1 is a schematic diagram of an exemplary configuration of a transaction processing system according to one embodiment of the present invention.

FIG. 2 is a schematic diagram of exemplary transaction control in a normal state according to one embodiment of the present invention.

FIG. 3 is a schematic diagram of exemplary transaction control in an exception-occurrence state according to one embodiment of the present invention.

FIG. 4 is a schematic diagram of exemplary transaction control in an exception-occurrence state according to one embodiment of the present invention.

FIG. 5 is a schematic diagram of exemplary transaction control in an exception-occurrence state according to a conventional technique.

### DESCRIPTION OF EMBODIMENTS

An embodiment of the present invention will be described below in detail on the basis of the drawings. Note that, in all the drawings describing the embodiment, the same elements are denoted with the same reference signs, and the duplicated descriptions thereof will be omitted. Meanwhile, an element described with a reference sign with reference to one drawing may be mentioned again with the same reference sign in the description with reference to other drawings in which the element is not illustrated.

### <System Configuration>

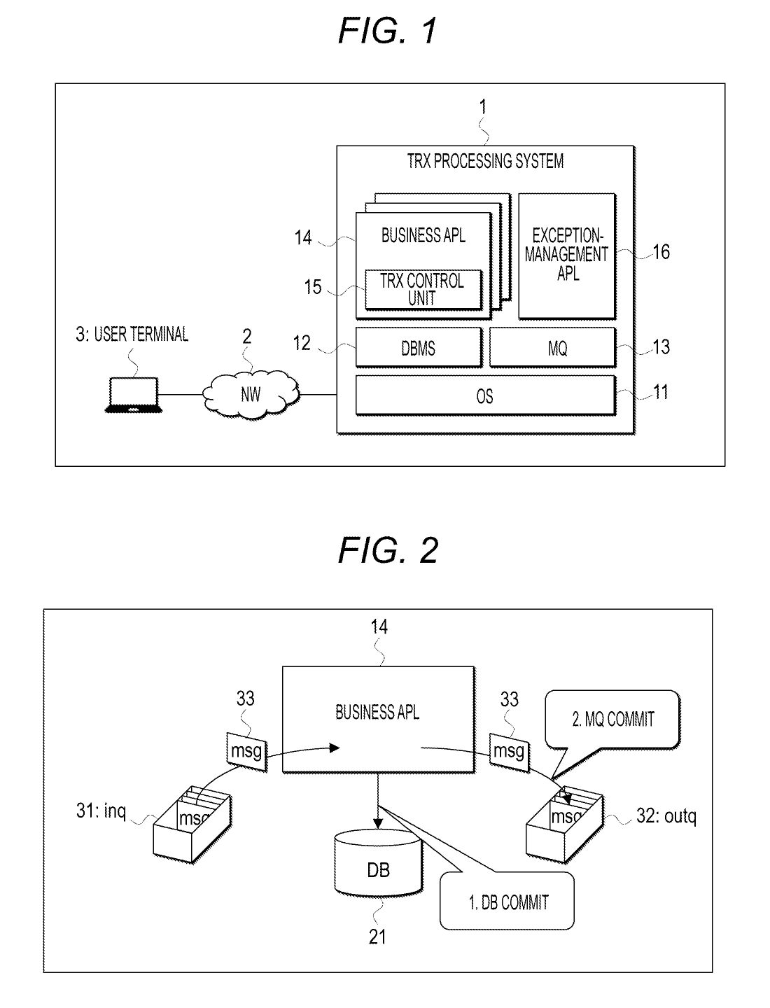

FIG. 1 is a schematic diagram of an exemplary configuration of a transaction processing system according to one embodiment of the present invention. The transaction (TRX) processing system 1 includes, for example, a server system including server equipment or a virtual server constructed in cloud computing environment, operated and managed by an operator, and provides various business services with transaction processing, to at least one service provider being a user who utilizes a user terminal 3 through a network (NW) 2, such as the Internet.

The TRX processing system 1 includes an operating system (OS) 11, a database management system (DBMS) 12, middleware such as a message queue (MQ) 13, at least one business application (APL) 14 having a transaction (TRX) control unit 15, implemented as software that operates thereon, and an exception-management application (APL) 16, as modules.

Business APLs 14 are application programs included in subsystems that achieve a series of services, the application programs cooperating with each other in a “bucket brigade” manner through queues provided from the MQ 13. The example of FIG. 1 illustrates the one TRX processing system 1 including all the business APLs 14 implemented, but the business APLs 14 may be dispersedly disposed in a plurality of server systems.

The business APLs 14 each includes the TRX control unit 15 as an infrastructure program. The TRX control unit 15 has a function of determining whether a message input through the queue includes incomplete data and performing, when determining that the message includes the incomplete data, processing in cooperation with the exception-management APL 16 to be described later, to inhibit exception occurrence due to the incomplete data from looping. The determination of whether the message includes the incomplete data is made on the basis of whether the intended message is identical to the message having caused the business exception before.

The exception-management APL 16 has a function of receiving the message determined as including the incomplete data to perform recovery processing of correcting the incompletion. For example, there is provided a user interface that notifies the user terminal 3 used by a person in charge of a service provider according to the intended message, of the effect of the exception occurrence, inhibits the intended incomplete data, receives correction to the incomplete data, and makes a retry to the intended business APL 14. If possible, a retry may be made with automatic correction without the correction of the user.

### <Transaction Control>

FIG. 2 is a schematic diagram of exemplary transaction control in a normal state according to the present embodiment. The figure exemplifies one extracted from the plurality of business APLs 14 in cooperation with each other in order to achieve a series of services. In the normal state, the business APL 14 starts a transaction and then GETs one message (msg) 33 PUT into an input queue (inq) 31 by the user terminal 3 or the previous business APL 14, the one message (msg) 33 queuing, to perform predetermined business processing on the basis of the contents of the one message (msg) 33. At this time, the business APL 14 accesses a database (DB) 21 retaining, for example, business data and log information.

Performance of all the business processing causes the msg 33 according to a processing result to be PUT into an output queue (outq) 32. The contents of the msg 33 may be the same as those input, or may have been as necessary rewritten by the business APL 14. After that, the database and the MQ are committed to finalize the updated contents to the DB 21 and the contents of the GET/PUT processing of the msg 33 to the inq 31 and the outq 32. Then, the transaction finishes so that the business APL 14 can perform the next transaction.

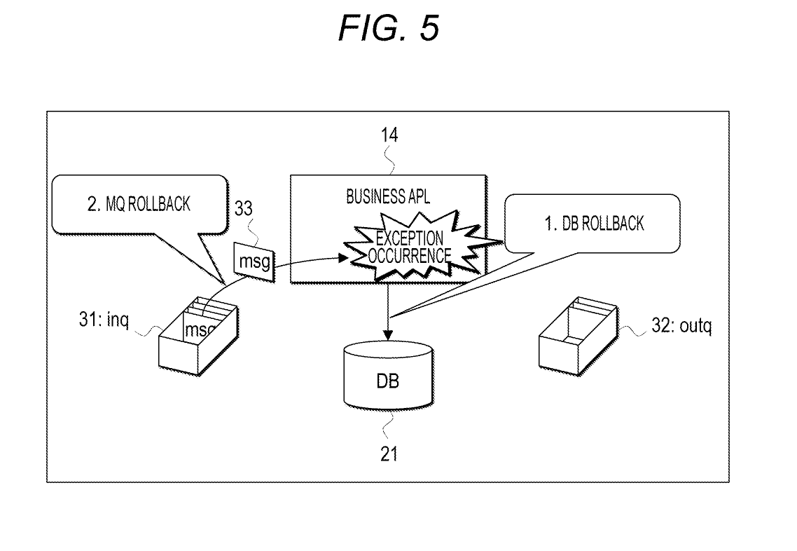

FIG. 5 is a schematic diagram of exemplary transaction control in an exception-occurrence state according to a conventional technique. Similarly to the example of FIG. 2, a business APL 14 starts a transaction and GETs a msg 33 from an inq 31. In a case where an exception occurs on the basis of incompletion in the contents of the msg 33 during performance of predetermined business processing including accessing to a DB 21 on the basis of the contents of the msg 33, the database and MQ both are rolled back in the conventional technique. This arrangement returns the contents of the DB 21 to the state at the start of the transaction and additionally returns the msg 33 to the inq 31.

In this case, the business APL 14 GETs, as the next transaction, the msg 33 having the incompletion from the inq 31 again to perform the business processing. As a result, the exception occurrence in the same status based on the incompletion in the contents of the msg 33, loops. As a result, processing of the subsequent message queuing in the inq 31 including a message according to a different service provider, is delayed.

Meanwhile, typically, the operator is not allowed to destroy or correct even the msg 33 having the incompletion on its own, and thus processing by the intended service provider or processing based on approval or an instruction of the intended service provider, is required. Therefore, in the TRX processing system 1 according to the present embodiment, passing the msg 33 having the incomplete data according to the exception occurrence, from the business APL 14 to the exception-management APL 16, enables processing of the subsequent message queuing in the inq 31 and additionally enables the intended service provider to independently deal with the msg 33 having the incomplete data through the exception-management APL 16.

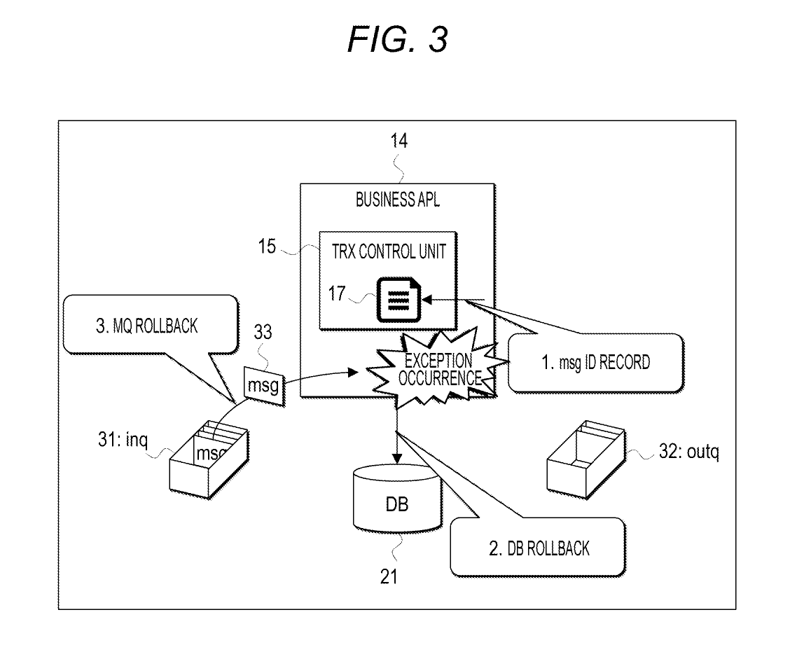

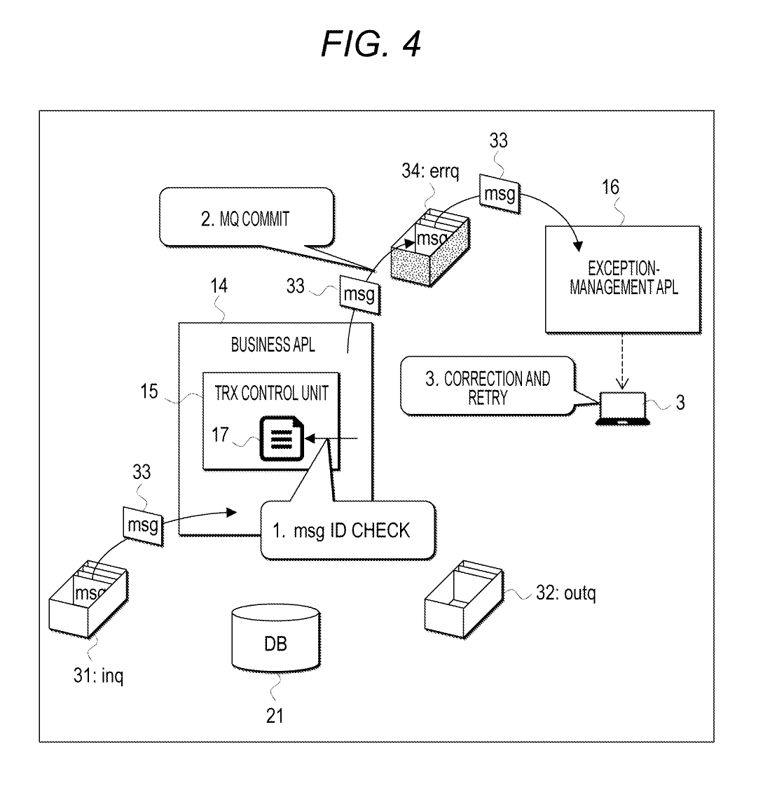

FIGS. 3 and 4 are schematic diagrams of exemplary transaction control in the exception-occurrence state according to the present embodiment. Similarly to the example of FIG. 5, FIG. 3 illustrates, after the business APL 14 starts a transaction and GETs a msg 33 from the inq 31, occurrence of an exception based on incompletion in the contents of the msg 33 during performance of the predetermined business processing including the accessing to the DB 21 on the basis of the contents of the msg 33.

In this case, according to the present embodiment, the TRX control unit 15 first records unique identification information (msg ID), such as an ID or a sequence number, set in the intended msg 33, into an exception-management table 17. A method of implementing the exception-management table 17 is not particularly limited, but, for example, a table or a file expanded in a memory can be used. After that, the database and the MQ both are rolled back, similarly to the example of FIG. 5. This arrangement returns the contents of the DB 21 to the state at the start of the transaction and additionally returns the msg 33 to the inq 31.

Next, as illustrated in FIG. 4, the business APL 14 GETs the msg 33 having the incompletion again from the inq 31 as the next transaction. Here, before starting the business processing, the TRX control unit 15 acquires the msg ID set in the intended msg 33 and checks whether the same msg ID has been registered in the exception-management table 17. In a case where the same msg ID has not been registered, it is determined that the intended msg 33 has caused no business exception before, and the business APL 14 performs the business processing on the basis of the msg 33 as usual.

Meanwhile, in a case where the intended msg ID has been registered in the exception-management table 17, it can be determined that the business processing has already been performed on the basis of the intended msg 33 and a rollback has been made due to the business exception caused during the business processing. In this case, the business APL 14 (or TRX control unit 15) PUTs the intended msg 33 into an error queue (errq) 34. At this time, various types of information regarding the exception may be added to the msg 33. After that, the MQ is committed (database may be committed together) to finalize the contents of the GET/PUT processing of the msg 33 to the inq 31 and the errq 34. Then, the transaction finishes so that the business APL 14 can perform the next transaction. At this time, the TRX control unit 15 may delete the entry of the intended msg ID registered in the exception-management table 17.

Then, the exception-management APL 16 operating as a different subsystem, GETs the msg 33 queuing in the errq 34 (or a corresponding queue having received the msg 33 transferred from the errq 34) and then performs recovery processing in asynchronization with the business APL 14. For example, the exception-management APL 16 notifies the user terminal 3 used by a person in charge of the intended service provider, of the effect of the exception occurrence, exhibits the contents of the intended msg 33 and the contents of the exception, receives deletion of the cause of the exception, such as correction, and an instruction for a retry to the business APL 14 (namely, a retry with PUT to the inq 31), and makes the retry. If possible, a retry may be made to the business APL 14 with, for example, automatic correction without the instruction of the user.

As described above, in the TRX processing system 1 according to one embodiment of the present invention, in a case where a msg 33 having incomplete data is input from the inq 31 to the business APL 14, making a rollback with recording of the msg ID thereof into the exception-management table 17, enables the msg 33 to be distinguished even in a case where the msg 33 is input again, so that the msg 33 can pass to the exception-management APL 16 through the errq 34. This arrangement enables the business APL 14 to continue to perform processing of the subsequent message queuing in the inq 31, so that the availability can improve with no influence on the processing of the subsequent message including a message according to a different service provider.

Through the exception-management APL 16, the service provider according to the intended msg 33 can make a retry to the business APL 14 with deletion of the cause of the exception, such as correction, independently. Thus, the incomplete data can be recovered with no increase in the operation burden of the operator, so that the availability can improve.

The invention devised by the inventor has been specifically described so far based on the embodiment. However, it is needless to say that the present invention is not limited to the foregoing embodiment but can be modified in various manners without deviating from the gist of the present invention. For example, the foregoing embodiment has been described in detail for the ease of understanding the present invention, and the present invention is not necessarily limited to the embodiment including all the elements described above. In addition, part of the elements of the foregoing embodiment can be provided with a different element, deleted, or replaced by a different element.

For example, according to the foregoing embodiment, as illustrated in FIG. 4, the msg 33 including the incomplete data passes from the business APL 14 to the exception-management APL 16 through the errq 34, but the embodiment is not limited to this configuration. For example, the business APL 14 may pass the msg 33 to the exception-management APL 16 such that the business APL 14 writes, for example, the contents of the msg 33 and information regarding the exception, into an exception-management database not illustrated to enable the exception-management APL 16 to refer to the contents.

### INDUSTRIAL APPLICABILITY

The present invention is available to a transaction processing system and a transaction control method that perform control of, for example, delivering and receiving data with MQ.

### REFERENCE SINGS LIST

1 TRX processing system
2 NW
3 user terminal
11 OS
12 DBMS
13 MQ
14 business APL
15 TRX control unit
16 exception-management APL
17 exception-management table
21 DB
31 inq
32 outq
33 msg
34 errq

1. A transaction control system including at least one business application configured to perform transaction processing including: acquiring a first message from a first queue; performing business processing including accessing to a database, for at least one service provider, based on the first message; and outputting a second message to a second queue, the transaction control system comprising:
an exception-management table into which identification information regarding the first message is to be recorded, the first message having occurrence of an exception during the performance of the business processing,
wherein, the at least one business application acquires the first message from the first queue after starting the transaction processing, checks whether the identification information according to the first message acquired has been recorded in the exception-management table, performs the business processing in a case where no record has been made, outputs a third message including contents of the first message to a third queue according to exception processing in a case where the record has been made, and commits the transaction processing, and
the at least one business application records the identification information regarding the first message into the exception-management table in a case where the exception occurs during the performance of the business processing, and rolls back the transaction processing.

2. The transaction control system according to claim 1, further comprising:
an exception-management application configured to acquire the third message from the third queue to perform exception-management processing,
wherein the exception-management application outputs contents of the third message to the at least one service provider corresponding to the contents of the third message, receives an instruction from the at least one service provider, corrects the first message included in the third message, and outputs the first message corrected to the first queue.

3. A transaction control method in a transaction control system including at least one business application configured to perform transaction processing including: acquiring a first message from a first queue; performing business processing including accessing to a database, for at least one service provider, based on the first message; and outputting a second message to a second queue, the transaction control method comprising the steps of, by the at least business application:
acquiring the first message from the first queue after starting the transaction processing, checking whether the identification information according to the first message acquired has been recorded in an exception-management table, the performing the business processing in a case where no record has been made, outputting a third message including contents of the first message to a third queue according to exception processing in a case where the record has been made, and committing the transaction processing; and
recording the identification information regarding the first message into the exception-management table in a case where an exception occurs during the performing the business processing, and rolling back the transaction processing.

4. The transaction control method according to claim 3, further comprising the step of, by an exception-management application configured to acquire the third message from the third queue to perform exception-management processing:
outputting contents of the third message to the at least one service provider corresponding to the contents of the third message, receiving an instruction from the at least one servicer provider, correcting the first message included in the third message, and outputting the first message corrected to the first queue.
